(19) United States
(12) Patent Application Publication
(10) Pub. No.: US 2025/0233376 A1
(43) Pub. Date: Jul. 17, 2025

(54) PLUG WITH TEMPERATURE-CONTROLLED CIRCUIT BREAKER

(71) Applicant: AuOne ELECTRONIC MANUFACTURING LIMITED, Gaoming (CN)

(72) Inventors: Chi Man Ao, Gaoming (CN); Ka Seng Ao, Gaoming (CN); Hehua Li, Gaoming (CN); Ziheng Chen, Gaoming (CN)

(21) Appl. No.: 18/783,349

(22) Filed: Jul. 24, 2024

(30) Foreign Application Priority Data
Jan. 11, 2024 (CN) 2024100391827

(51) Int. Cl. H01R 13/713; H01R 24/30

(52) U.S. Cl. CPC H01R 13/7137; H01R 24/30

(57) ABSTRACT

A plug with a temperature-controlled circuit breaker can include a main body; a lead end; a live wire pin; and a neutral wire pin; wherein the lead end is fixed on a first end of the main body, wherein the live wire pin and the neutral wire pin are provided on a second end of the main body, and wherein an overheat/overcurrent protection component is connected in series between the lead end and the live wire pin, or an overheat/overcurrent protection component is connected in series between the lead end and the neutral wire pin.

### CROSS-REFERENCE TO RELATED APPLICATIONS

This application claims the benefit of priority of Chinese Patent Application No. 2024100391827, filed Jan. 11, 2024, which is incorporated herein by reference.

### TECHNICAL FIELD

The present disclosure relates to the technical field of electrical plugs, more particularly to a plug with a temperature-controlled circuit breaker.

### BACKGROUND

At present, common electrical power cord plugs available on the market are manufactured by directly connecting two pins to a power cord (that is, a live wire and a neutral wire) and then molding by injection of PVC. A power plug includes pins, a support, and a lead. Each pin has one end connected to one end of the lead within the support, while another end of the lead is exposed out of the support for insertion into a power socket to interface with a power supply, where the power supply is fed to an electrical appliance through the lead. The support is configured to insulate each pin and insulate electrified parts from the outside world. To guarantee the safety of electricity usage, generally, power supply circuits and electrical appliances are provided with overload and short circuit protection mechanisms therein. Once a short circuit occurs, a main fuse of the power supply circuit will trip, or an internal protection circuit inside the electrical appliance will short circuit, which could affect other electrical appliances, and disrupt everyday work and life.

At present, common three-phase plugs have two specifications for ground wire pins. One is in a cylindrical shape and one is in a flat sheet shape, which are not interchangeable. Multiple plugs need to be carried during usage because each plug is made to only one specification. Particularly, for present plugs, when a lead end and a shell are assembled through a connection structure, an adhesive is further needed to adhere them together. If a plug is damaged, it can only be discarded rather than repaired, resulting in a waste of resources. Further, the plug and the socket can easily loosen from each other after a period of usage leading to poor contact, and can burn out the plug and the socket.

Therefore, the existing technology needs to be improved and further developed.

### SUMMARY

In view of the shortcomings and deficiencies of the existing technologies, the present disclosure aims to provide a plug with a temperature-controlled circuit breaker which is reasonably structured, widely compatible, and safe to use.

In order to achieve the above aim, the present disclosure employs the following technical embodiments.

A plug with a temperature-controlled circuit breaker can include a main body; a lead end; a live wire pin; and a neutral wire pin; wherein the lead end is fixed on a first end of the main body, wherein the live wire pin and the neutral wire pin are provided on a second end of the main body, and wherein an overheat/overcurrent protection component is connected in series between the lead end and the live wire pin, or an overheat/overcurrent protection component is connected in series between the lead end and the neutral wire pin.

A plug with temperature-controlled circuit breaker can include an overheat/overcurrent protection component comprising: a connecting terminal; a fixed contact piece; and a bimetallic strip; wherein the connecting terminal is fixedly connected to the fixed contact piece by an insulated terminal, and a static contact is arranged on the connecting terminal, wherein the bimetallic strip has a first end fixedly connected to the fixed contact piece and the bimetallic strip has a second end provided with a moving contact, and wherein either a live wire pin is fixedly connected to the fixed contact piece and a live wire at a lead end is connected to the connecting terminal of the overheat/overcurrent component, or a neutral wire pin is fixedly connected to the fixed contact piece and a neutral wire at the lead end is connected to the connecting terminal of the overheat/overcurrent protection component.

The plug with temperature-controlled circuit breaker according to claim 16, further comprising: a second overheat/overcurrent protection component comprising: a second connecting terminal; a second fixed contact piece; and a second bimetallic strip; wherein the second connecting terminal is fixedly connected to the second fixed contact piece by a second insulated terminal, wherein a second static contact is arranged on the second connecting terminal, wherein the second bimetallic strip has a first end fixedly connected to the second fixed contact piece and a second end with a second moving contact, wherein a live wire pin is fixedly connected to the fixed contact piece, wherein a neutral wire pin is fixedly connected to the second fixed contact piece, wherein a live wire at a lead end is connected to the connecting terminal of the overheat component, and wherein a neutral wire at the lead end is connected to the second connecting terminal of the second overheat/overcurrent protection component.

A plug with temperature-controlled circuit breaker can include a positive temperature coefficient (“PTC”) element bridging the connecting terminal and the bimetallic strip, or a PTC element bridging the second connecting terminal and the second bimetallic strip.

A plug with temperature-controlled circuit breaker can include a moving contact welded onto the bimetallic strip with a molten material, a static contact welded onto the connecting terminal with a molten material, a second moving contact welded onto a second bimetallic strip using a molten material, or a second static contact welded onto a second connecting terminal using a molten material.

A plug with temperature-controlled circuit breaker can include a main body provided with a ground wire pin, and wherein the ground wire pin is electrically connected to a lead end.

A plug with temperature-controlled circuit breaker can include a main body further comprising: a shell; and a positioning module; wherein the shell is a hollow structure with an upper opening, wherein located within the upper opening of the shell is the positioning module composed of two constituent components which are arranged symmetrically, and are removably connected to each other to form a positioning opening, wherein a lead end comprises a neck groove, and wherein the neck groove is removably connected to the positioning opening such that the lead end is removably connected to the upper opening of the shell.

A plug with temperature-controlled circuit breaker can include a positioning module further comprising a plurality of limit blocks, wherein a live wire pin, a neutral wire pin, and a ground wire pin each comprise a folding plate, wherein a shell further comprises plug holes on a lower end surface of the shell, and wherein the live wire pin, the neutral wire pin, and the ground wire pin insert through the plug holes of the shell, and wherein the limit blocks on the positioning module abut against the folding plates of the live wire pin, the neutral wire pin, and the ground wire pin.

A plug with temperature-controlled circuit breaker can include a positioning module further comprising a fixing hole, and wherein the positioning module is fixedly connected to a shell by the fixing hole and a fastener.

A plug with temperature-controlled circuit breaker can include a limit block and a ground wire pin defining an assembly groove, wherein a ground wire at a lead end is embedded into the limit block and extends into the assembly groove, and the ground wire pin has an upper end provided with a quick replacement component, wherein the quick replacement component comprises a conductive sleeve and a conductive pole, wherein the conductive pole is fixedly connected to the upper end of the ground wire pin, and the conductive pole is slidably inserted into the conductive sleeve, wherein the conductive sleeve has an upper end plate with a conductive pin, the conductive pin has an upper end with a second disc, and the conductive sleeve is slidably inserted into the assembly groove, wherein the second disc contacts and is electrically connected to the ground wire, and the assembly groove is provided a first locking structure, wherein a slide rod passes through the upper end plate of the conductive sleeve, wherein the slide rod has a lower end fixedly connected to the conductive pole, wherein the slide rod has an upper end provided with a first disc, wherein the first disc and the second disc are positioned about a first locking structure, below and above the first locking structure respectively, and wherein inside the conductive sleeve is a first spring, and the first spring abuts the upper end plate of the conductive sleeve and an upper end surface of the conductive pole.

A plug with temperature-controlled circuit breaker can include a first locking structure comprising a first guide rod and a slope limit seat, wherein a first chute is defined by walls of an assembly groove, wherein inside the first chute is a first guide rod and an elastic element, wherein the first guide rod has a first end fixedly connected to the assembly groove, wherein the slope limit seat is slidably arranged on a second end of the first guide rod, wherein the elastic element abuts against the slope limit seat, and wherein the slope limit seat is removably connected to the first disc.

A plug with temperature-controlled circuit breaker can include a second locking structure located between a ground wire pin and a shell, wherein the second locking structure comprises a second chute, a second guide rod, and a columnar locking tab, wherein the second chute is arranged within the shell and adjacent to a conductive pole, wherein the second chute contains the second guide rod and an elastic element, wherein the conductive pole defines a first locking groove connected to the second chute, wherein the second guide rod has a first end fixedly connected to the second chute, wherein the columnar locking tab is slidably arranged on a second end of the second guide rod, wherein the elastic element abuts against the columnar locking tab, and wherein the columnar locking tab is removably connected to the first locking groove.

A plug with temperature-controlled circuit breaker can include an assistant pairing structure arranged between a positioning module and a lead end, wherein the assistant pairing structure comprises a lock box containing a driving slider, a third guide rod, and a wedged driving head, wherein the lock box is arranged adjacent to an upper end of the positioning module, wherein the third guide rod is fixedly arranged inside the lock box and the driving slider is slidably connected to the third guide rod, and the lock box has an upper end surface defining a maintenance opening, wherein inside a neck groove is defined a second locking groove, wherein one end of the lock box is provided with a locking head inserted into the neck groove in a removably connected state, and the locking head is provided an elastic fastener, wherein the wedged driving head is fixedly connected to the driving slider by a synchronous connecting rod, wherein inside the lock box is positioned an elastic element which abuts against the driving slider, and wherein the elastic fastener is fitted about the wedged driving head.

A plug with temperature-controlled circuit breaker can include an assistant assembly structure arranged between a positioning module and a shell, wherein the assistant assembly structure comprises a steel ball, a rubber block, and an elastic element in a third locking groove defined within the positioning module, wherein the third locking groove has a first end extending through an outer wall of the positioning module to form an opening, wherein the shell has an inner wall defining a limit recess, wherein the rubber block and the steel ball are inserted into the opening of the first end of the third locking groove, and wherein an elastic element is arranged within the third locking groove and the elastic element drives the rubber block and the steel ball toward the limit recess.

A plug with temperature-controlled circuit breaker can include a third locking groove having a second end provided with an adjusting screw, wherein the adjusting screw is in threaded connection with the third locking groove, and wherein an adjusting press plate is arranged inside the third locking groove, the adjusting screw having one end connected to the adjusting press plate, and an elastic element is arranged between the adjusting press plate and the rubber block.

A plug with temperature-controlled circuit breaker can include a main body; a lead end comprising a neck groove; a shell; a positioning module; a first pin; a second pin; a third pin; at least one overcurrent/overheat protection component; wherein the lead end is fixed on a first end of the main body, and the first pin, the second pin, and the third pin are provided on a second end of the main body, wherein the at least one overheat/overcurrent protection component is connected in series between the lead end and the first pin, or the at least one overheat/overcurrent protection component is connected in series between the lead end and the second pin, wherein the shell is a hollow structure with an upper opening, and further comprises plug holes on a lower end surface of the shell, wherein the positioning module is composed of at least two constituent components combined by removeable connection, and comprises a plurality of limit blocks, wherein the positioning module defines a positioning opening, and the positioning module fits within the upper opening of the shell, wherein the neck groove is removably connected to the positioning opening of the positioning module such that the lead end is removably connected to the upper opening of the shell, wherein the first pin, the second pin, and the third pin each comprise a folding plate, wherein the first pin, the second pin, and the third pin insert through the plug holes of the shell, and wherein the limit blocks abut against the folding plates.

A plug with temperature-controlled circuit breaker can include a first locking structure; and wherein the first locking structure unlocks a third pin when the third pin is slid upward.

A plug with temperature-controlled circuit breaker can include an assistant pairing structure comprising a maintenance opening; wherein the assistant pairing structure couples the positioning module to the lead end, and wherein the positioning module is separable from the lead end when a tool is applied to the maintenance opening.

A plug with temperature-controlled circuit breaker can include an assistant assembly structure; and an adjusting screw; wherein the assistant assembly structure locks the vertical positioning between a positioning module and a shell, wherein the assistant assembly structure disengages the shell from the positioning module when a vertical force is applied to either the shell or the positioning module, and wherein the vertical force required to disengage the shell from the positioning module is modifiable with the adjusting screw.

A plug with temperature-controlled circuit breaker can include a main body; a lead end which comprises a neck groove; a shell; a positioning module; a live wire pin; a neutral wire pin; a ground wire pin; at least one overcurrent/overheat protection components; a first locking structure; a second locking structure; an overheat/overcurrent protection component; an assistant pairing structure; an assistant assembly structure; and an adjusting screw; wherein the lead end is fixed on a first end of the main body, wherein the live wire pin, the neutral wire pin, and the ground wire pin are provided on a second end of the main body, wherein the overheat/overcurrent protection component is connected in series between the lead end and the live wire pin, or the overheat/overcurrent protection component is connected in series between the lead end and the neutral wire pin, wherein the shell is a hollow structure with an upper opening, and a lower end surface of the shell further comprises plug holes, wherein the positioning module define a positioning opening, wherein the positioning module comprises a plurality of limit blocks, wherein the positioning module fits within the upper opening of the shell, wherein the neck groove is removably connected to the positioning opening of the positioning module such that the lead end is removably connected to the upper opening of the shell, wherein the live wire pin, the neutral wire pin, and the ground wire pin each comprise a folding plate, wherein the live wire pin, the neutral wire pin, and the ground wire pin insert through the plug holes of the shell, wherein the limit blocks abut against the folding plates of the live wire pin, the neutral wire pin, and the ground wire pin, wherein the second locking structure unlocks the ground wire pin when the ground wire pin is rotated, wherein, after the second locking structure is unlocked, the first locking structure unlocks the ground wire pin when the ground wire pin is slid upward, wherein the assistant pairing structure comprises a maintenance opening, wherein the use of a tool applied to the maintenance opening allows the positioning module to separate from the lead end, wherein the assistant assembly structure disengages the shell from the positioning module when a vertical force is applied to either the shell or the positioning module, and wherein the vertical force required to disengage the shell from the positioning module is modifiable with the adjusting screw.

The present disclosure has a number of possible beneficial effects. The present disclosure is reasonable in structure. Inside the plug main body is an overheat/overcurrent protection component which, when poor contact, short circuit, and the like occur in a circuit resulting in overheat and overcurrent between the plug and a socket, the component automatically cuts off the circuit between the lead end and the pin, preventing the plug and the socket from burning out and avoids impacting other electrical appliances.

### BRIEF DESCRIPTION OF THE DRAWINGS

FIG. 1 is a structural diagram of the present disclosure with shell removed.

FIG. 2 is a structural diagram of the present disclosure in a state of disassembly.

FIG. 3 is a structural diagram of a ground wire pin assembled with a limit block according to the present disclosure.

FIG. 4 is a detailed structural diagram of part A shown in FIG. 3.

FIG. 5 is a detailed structural diagram of part B shown in FIG. 3.

FIG. 6 is a structural diagram of a ground wire pin and a quick replacement component according to the present disclosure.

FIG. 7 is a structural diagram of a lead end assembled with a positioning module according to the present disclosure.

FIG. 8 is a detailed structural diagram of part C shown in FIG. 7.

FIG. 9 is a detailed structural diagram of part D shown in FIG. 7.

FIG. 10 is a detailed structural diagram of part E shown in FIG. 7.

Below is the listing of reference numerals on the drawings.

1, main body; 2, lead end; 3, connecting terminal; 4, PTC element; 11, shell; 12, positioning module; 13, positioning opening; 14, limit block; 15, plug holes; 16, fixing hole; 21, live wire pin; 22, neutral wire pin; 23, ground wire pin; 24, neck groove; 25, folding plate; 31, fixed contact piece; 32, bimetallic strip; 33, insulated terminal; 34, moving contact; 35, static contact; 110, second chute; 111, second guide rod; 112, columnar locking tab; 113, limit recess; 114, adjusting screw; 115, adjusting press plate; 120, lock box; 121, driving slider; 122, third guide rod; 123, wedged driving head; 124, locking head; 125, elastic fastener; 126, synchronous connecting rod; 127, steel ball; 128, rubber block; 129, third locking groove; 141, first guide rod; 142, slope limit seat; 143, first chute; 231, assembly groove; 232, conductive sleeve; 233, conductive pole; 234, conductive pin; 235, second disc; 236, slide rod; 237, first disc; 238, first spring; 239, first locking groove; 241, second locking groove.

### DETAILED DESCRIPTION OF THE EMBODIMENTS

The technical scheme of the present disclosure is described below in conjunction with the drawings and embodiments.

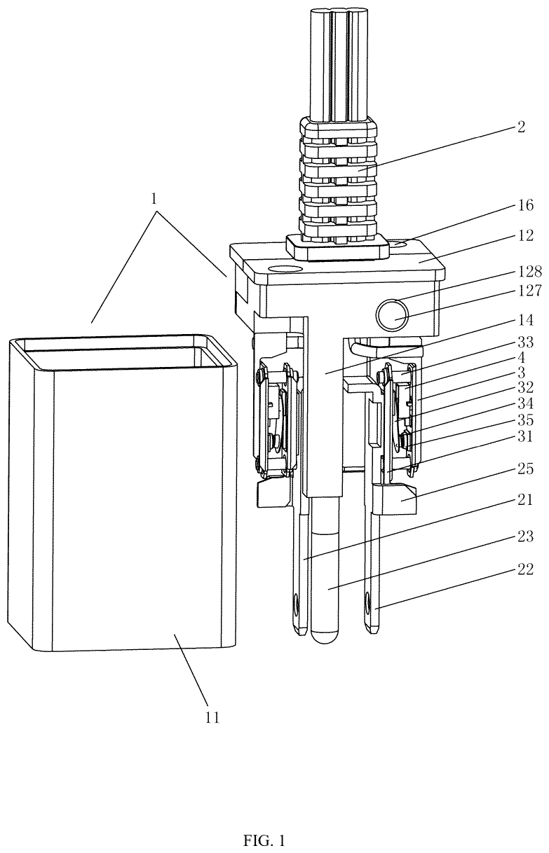

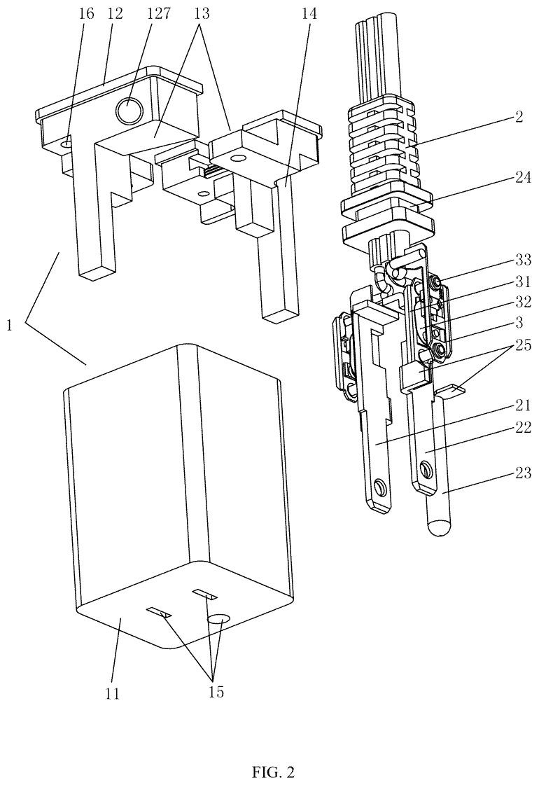

As illustrated in FIG. 1 to FIG. 2, the plug with temperature-controlled circuit breaker according to the present disclosure includes a main body 1 and a lead end 2. The lead end 2 is fixed on a first end of the main body 1. A second end of the main body 1 is provided with a live wire pin 21 and a neutral wire pin 22. The main body 1 can further be provided with a ground wire pin 23. Between the lead end 2 and the live wire pin 21 and/or between the lead end 2 and the neutral wire pin 22 are/is connected in series to overheat/overcurrent protection component(s). The overheat/overcurrent protection component is positioned in the main body 1 to connect the lead end 2 with the live wire pin 21 or the neutral wire pin 22 in series. When the plug main body 1 is inserted into a power supply socket for an electrical appliance, if poor contact, load short, or the like occur between the plug and the socket, resulting in excessive current and over temperature, the overheat/overcurrent protection component can respond in time and cut off the current path on the live wire pin 21 or the neutral wire pin 22, thereby preventing the plug main body 1 and the socket from burning out. Furthermore, only after plug main body 1 powers off and any issues are resolved, can the overheat/overcurrent protection component be reset and repowered, thereby avoiding frequent disconnection of the power supply which can otherwise render other electrical appliance unusable, and can adversely impact daily life.

The overheat/overcurrent protection component includes a connecting terminal 3, a fixed contact piece 31, and a bimetallic strip 32. The connecting terminal 3 is fixedly connected to the fixed contact piece 31 by an insulated terminal 33. The bimetallic strip 32 has a first end fixedly connected to the fixed contact piece 31. The bimetallic strip 32 has a second end provided with a moving contact 34, and a static contact 35 is arranged on the connecting terminal 3. The live wire pin 21 and the neutral wire pin 22 are each fixedly connected to corresponding fixed contact pieces 31. A live wire and a neutral wire at the lead end 2 can each be connected to connecting terminals 3 of two overheat components respectively. The live wire at the lead end 2 is welded to the connecting terminal 3, forming a series connection with the live wire pin 21 by using the overheat/overcurrent protection component. Similarly, the neutral wire at the lead end 2 is welded to the connecting terminal 3, forming a series connection with the neutral wire pin 22 by using the overheat/overcurrent protection component. Once an electrical overload or short circuit occurs on the circuit between an electrical appliance, the plug, and a socket, particularly when poor contact and the like occur between the plug and the socket, or when an electrical spark, temperature rise, or the like occur at the contact area between the plug and the socket during use of the electrical appliance, the bimetallic strip 32 can respond quickly and deform, cutting off the path between the moving contact 34 and the static contact 35, thereby disconnecting the current flow to protect the plug main body 1 and the socket. Preferably, two sets of overheat/overcurrent protection components are arranged inside the plug main body 1, providing dual protection and improving safety.

A positive temperature coefficient (“PTC”) element 4 is bridged between the connecting terminal 3 and the bimetallic strip 32. The PTC element 4 has a far greater value of resistance than the bimetallic strip 32. In normal conditions, the PTC element 4 and the bimetallic strip 32 are equivalent to being in parallel connection, and the PTC element 4 does not activate due to a very low division voltage, hence does not generate heat. When poor contact results in high temperature and short circuit, the bimetallic strip 32 trips to cut off the path between the moving contact 34 and the static contact 35, enabling the PTC element 4 to receive a working voltage, and the PTC element 4 generates heat to maintain the thermal deformation state of the bimetallic strip 32. Therefore, the plug main body 1 needs to power off to reduce the temperature of the PTC element 4 before it can be reused, thereby implementing a power-off reset function and avoiding power supply circuit trips caused by an electrical appliance restarting before electrical issues can be resolved.

The moving contact 34 is welded onto the bimetallic strip 32 employing a molten material, or the static contact 35 is welded onto the connecting terminal 3 employing a molten material. The molten material can achieve a fusing effect. When the overheat/overcurrent protection component has a failure, the molten material on the moving contact 34 or the static contact 35 also fails, thereby causing the moving contact 34 and the static contact 35 to disengage and forcing the power off, protecting the socket, the electrical appliance, and the whole power supply circuit.

The main body 1 includes a shell 11 and at least one positioning module 12. The shell 11 is a hollow structure with an upper opening. Inside the upper opening of the shell 11 is provided positioning module 12, and the positioning module 12 comprises at least two constituent components which are removably connected, such as by snap-fitting. The constituent components are arranged symmetrically such that positioning module 12 forms a positioning opening 13. The lead end 2 defines a neck groove 24. The neck groove 24 is removably connected to the positioning opening 13, whereby the lead end 2 is fixed toward the upper opening of the shell 11. The shell 11 employs injection molding processes and has insulating properties, and is used to assemble the internal overheat/overcurrent protection component and circuit. The lead end 2 is first welded with the connecting terminal 3. The lead end 2 is positioned within the positioning module 12, which is placed about the neck groove 24. The shell 11 defines plug holes 15 on a lower end surface. The live wire pin 21, the neutral wire pin 22, and the ground wire pin 23 are aligned with plug holes 15 on shell 11, and then are installed through the upper opening of the shell 11. The positioning module 12 defines a fixing hole 16, and the positioning module 12 can be fixedly connected to the shell 11 by a fastener, such as a bolt, and the fixing hole 16, thereby allowing quick assembly.

The positioning module 12 is provided with a plurality of limit blocks 14. The live wire pin 21, the neutral wire pin 22, and the ground wire pin 23 are each provided with a folding plate 25. The shell 11 defines plug holes 15 on a lower end surface thereof. The live wire pin 21, the neutral wire pin 22, and the ground wire pin 23 insert through corresponding plug holes 15. The limit blocks 14 on the positioning module 12 are connected to and abut against the folding plates 25 on the live wire pin 21, the neutral wire pin 22, and the ground wire pin 23 respectively. The limit blocks 14 abut against the folding plates 25, limiting any movement of live wire pin 21, the neutral wire pin 22, and the ground wire pin 23 within shell 11, preventing any loosening of the pins, increasing the stability of the overheat/overcurrent protection components and prolonging the service life of the product.

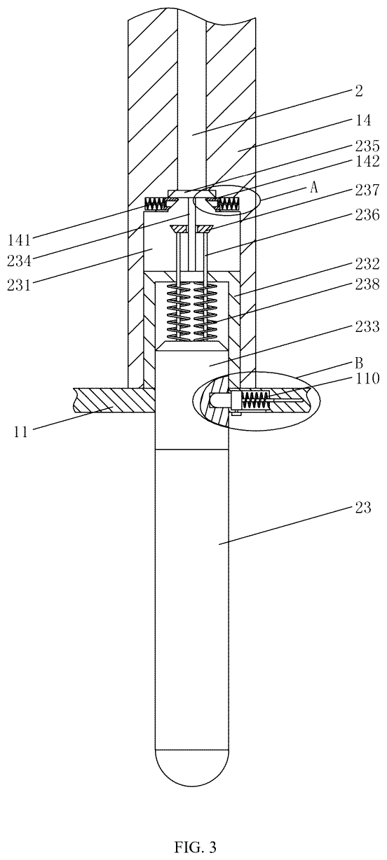

As illustrated in FIG. 3, the limit block 14 paired with the ground wire pin 23 defines thereon an assembly groove 231, a ground wire at the lead end 2 is embedded into the limit block 14 and extends into the assembly groove 231, and the ground wire pin 23 has an upper end provided with a quick replacement component. The quick replacement component comprises a conductive sleeve 232 and a conductive pole 233. The conductive pole 233 is fixedly connected to the upper end of the ground wire pin 23, and the conductive pole 233 is slidably inserted into the conductive sleeve 232. The conductive sleeve 232 has an upper end plate with a conductive pin 234. The conductive pin 234 has an upper end with a second disc 235. The conductive sleeve 232 is slidably inserted into the assembly groove 231, whereby the second disc 235 contacts and is electrically connected to the ground wire. The assembly groove 231 is provided at least one first locking structure. A slide rod 236 passes through the upper end plate of the conductive sleeve 232. The slide rod 236 has a lower end fixedly connected to the conductive pole 233; and the slide rod 236 has an upper end provided with a first disc 237. The first disc and the second disc are positioned about the first locking structure, below and above the first locking structure respectively. Inside the conductive sleeve 232 is a first spring 238, and the first spring 238 abuts against the upper end plate of the conductive sleeve 232 and an upper end surface of the conductive pole 233. The ground wire pin 23 can be removed and replaced by using the quick replacement component. The conductive sleeve 232 and the conductive pole 233 are assembled on the ground wire pin 23, and a corresponding limit block 14 defines thereupon an assembly groove 231. When the ground wire pin 23 is being assembled, the second disc 235 is inserted into the assembly groove 231, and the first locking structure locks the second disc 235, whereby the second disc 235 is electrically connected to and abuts against the ground wire at the lead end 2. The second disc 235, the conductive pin 234, the conductive sleeve 232, the conductive pole 233, and the ground wire pin 23 are connected in sequence to form part of a ground circuit.

To remove the ground wire pin 23, the ground wire pin 23 is pushed upward along a vertical direction, wherein the conductive pole 233 drives the first disc 237 upward via the slide rod 236, and the first disc 237 squeezes against the first locking structure to unlock the same, thereafter the second disc 235 can slide from the assembly groove 231, and the ground wire pin 23 can be removed from the limit block 14.

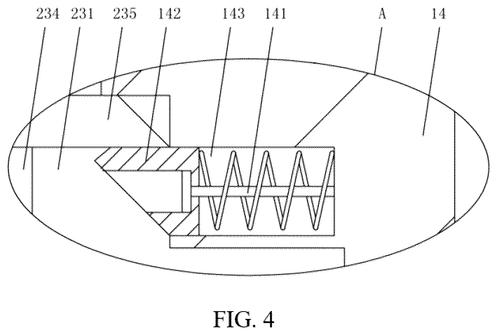

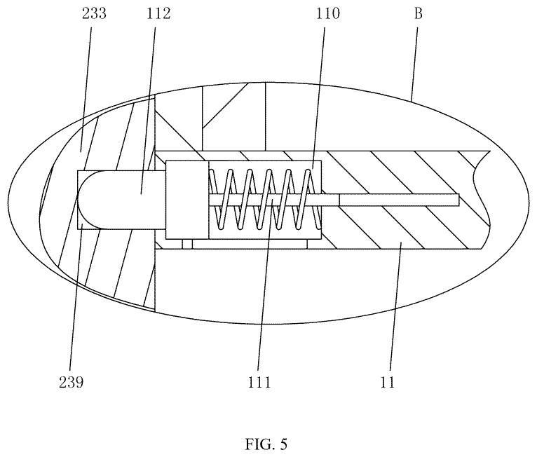

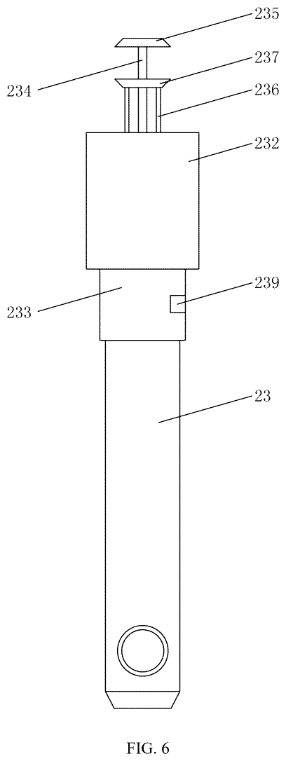

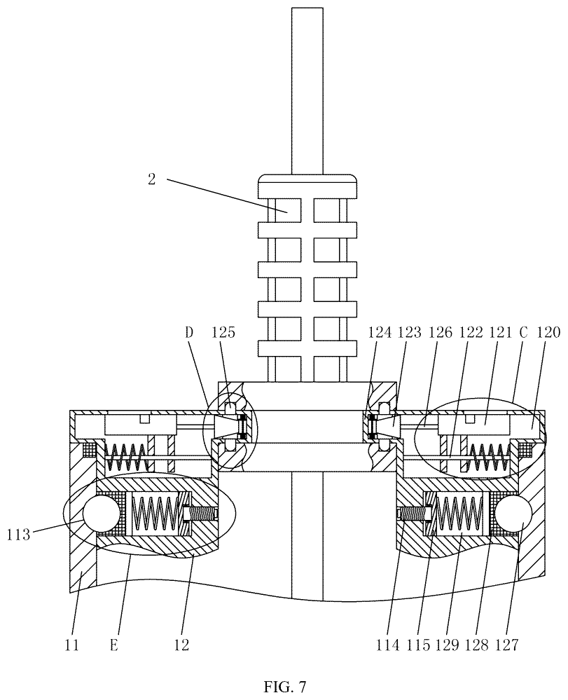

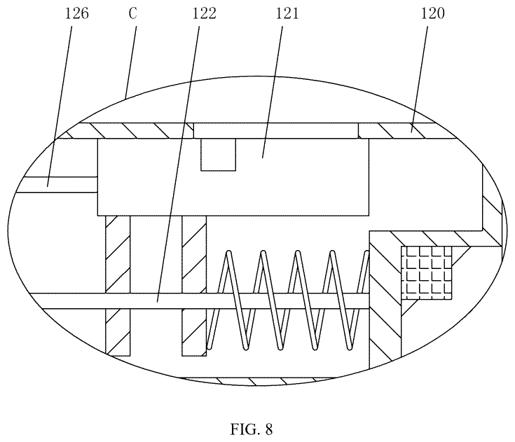

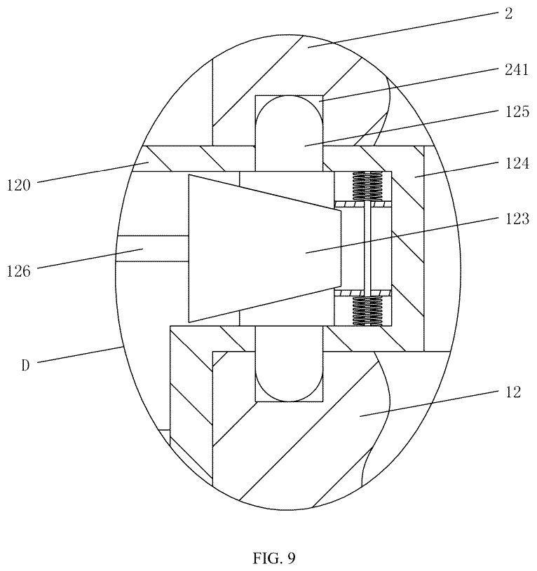

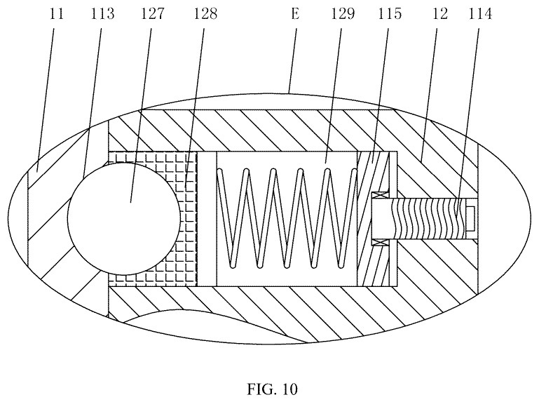

As illustrated in FIG. 3 to FIG. 10, specifically, the plug can include at least one first locking structure including a first guide rod 141 and a slope limit seat 142. The inner walls of the two sides of the assembly groove 231 each define a first chute 143. Inside the first chute 143 is provided the first guide rod 141 and an elastic element. The first guide rod 141 has a first end fixedly connected to the assembly groove 231. The slope limit seat 142 is slidably arranged on a second end of the first guide rod 141. The elastic element abuts against the slope limit seat 142, whereby the slope limit seat 142 is removably connected to the first disc 237. The slope limit seat 142 can move transversely along the first guide rod 141. The elastic element can be a spring. The elastic element drives the slope limit seat 142 toward the conductive pin 234. When assembled, the slope limit seat 142 abuts against the second disc 235 to lock the same. When the conductive pole 233 drives the first disc 237 to move upward, the first disc 237 pushes against a slope of the slope limit seat 142 and generates a transverse squeeze force to overcome the force of the elastic element, whereby the slope limit seat 142 retracts into the first chute 143 to unlock the second disc 235.

At least one second locking structure is located between the ground wire pin 23 and the shell 11. The second locking structure includes a second chute 110, a second guide rod 111, and a columnar locking tab 112. The second chute 110 is arranged within the shell 11 and adjacent to the conductive pole 233. The conductive pole 233 defines a first locking groove 239 connected to the second chute 110. Inside the second chute 110 is the second guide rod 111 and an elastic element. The second guide rod 111 has a first end fixedly connected to the second chute 110. The columnar locking tab 112 is slidably arranged on a second end of the second guide rod 111. The elastic element abuts against the columnar locking tab 112, whereby the columnar locking tab 112 is removably connected to the first locking groove 239. Preferably, the conductive pin 234 penetrates through the first disc 237, and the conductive pin 234 is rotatable relative to the conductive sleeve 232. In this way, the ground wire pin 23 can be removed by rotating the ground wire pin 23 so that the conductive pole 233 presses against the columnar locking tab 112, subjecting the columnar locking tab 112 to a pressure and columnar locking tab 112 thereby slides from the first locking groove 239 to retract into the second chute 110, allowing the second locking structure to unlock the ground wire pin 23. Thereafter, the ground wire pin 23 can slide upward to unlock the first locking structure.

At least one assistant pairing structure is arranged between the positioning module 12 and the lead end 2 and couples the positioning module 12 to the lead end 2. The assistant pairing structure includes a lock box 120 containing a driving slider 121, a third guide rod 122, and a wedged driving head 123. The lock box 120 is arranged adjacent to an upper end of the positioning module 12. The third guide rod 122 is fixedly arranged inside the lock box 120. The driving slider 121 is slidably connected to the third guide rod 122, and the lock box 120 has an upper end surface defining a maintenance opening. Inside the neck groove 24 is defined a second locking groove 241. One end of the lock box 120 is provided with a locking head 124. The locking head 124 is inserted into neck groove 24 in a removably connected state, and the locking head 124 is provided with an elastic fastener 125. The wedged driving head 123 is fixedly connected to the driving slider 121 by a synchronous connecting rod 126. Inside the lock box 120 is positioned an elastic element, and the elastic element abuts against the driving slider 121, whereby the elastic fastener 125 is fitted about the wedged driving head 123. The assistant pairing structure is used for quick assembly of the positioning module 12 and the lead end 2. The positioning module 12 clamps the lead end 2, and the neck groove 24 removably connects with the positioning opening 13. The locking head 124 on the lock box 120 is inserted into the neck groove 24. The elastic element drives the wedged driving head 123 to press against the elastic fastener 125, whereby the elastic fastener 125 is removably connected into the second locking groove 241, such that the positioning module 12 and the lead end 2 are quickly connected for convenient assembly into the shell 11. Of course, when a part inside the shell 11 needs repair, as the driving slider 121 has defined thereon a depression corresponding to the maintenance opening of lock box 120, a small tool can be used to engage the depression via the maintenance opening to separate the positioning module 12 from the lead end 2 by pushing the driving slider 121 away from the locking head 124, whereby the synchronous connecting rod 126 drives the wedged driving head 123 away from the elastic fastener 125. Thereafter, the elastic fastener 125 can be reset and disengaged from the second locking groove 241, allowing the positioning module 12 to separate from the lead end 2.

At least one assistant assembly structure is arranged between the positioning module 12 and the shell 11. The assistant assembly structure includes a steel ball 127, a rubber block 128, and an elastic element in a third locking groove 129 defined within the positioning module 12. The third locking groove 129 has a first end extending through an outer wall of the positioning module 12 to form an opening. The shell 11 has an inner wall, and defined thereon is a limit recess 113. The rubber block 128 and the steel ball 127 are inserted into the opening of the first end of the third locking groove 129. Inside the third locking groove 129 is provided an elastic element, and the elastic element drives the rubber block 128 and the steel ball 127 toward the limit recess 113. The positioning module 12 and the lead end 2 form an integrated structure which is then inserted into the upper opening of the shell 11, whereby the steel ball 127 is paired with the limit recess 113, the elastic element drives an outer end of the rubber block 128 against an inner wall of the shell 11, and the steel ball 127 is clamped into the limit recess 113, such that the vertical positioning is locked between the positioning module 12 and the shell 11 and the manner of locking is resilient. When a sufficiently large vertical force is applied to the positioning module 12 or the shell 1, the vertical force can overcome the force of the elastic element, disengaging the steel ball 127 from the limit recess 113, thereby facilitating subsequent disassembly and maintenance of the positioning module and the shell.

The third locking groove 129 has a second end provided with an adjusting screw 114 which can modify the vertical force required to disengage the steel ball 127, and thus the force required to disengage the positioning module 12 and the shell 11 from each other. The adjusting screw 114 is in threaded connection with the third locking groove 129. Inside the third locking groove 129 is an adjusting press plate 115. The adjusting screw 114 has one end connected to the adjusting press plate 115. The elastic element is arranged between the adjusting press plate 115 and the rubber block 128. Further, a friction force between the rubber block 128 and the shell 11 as well as a fit strength between the steel ball 127 and the limit recess 113 can be modified by the adjusting screw 114. The adjusting screw 114 can be rotated to drive the adjusting press plate 115 toward or away from the steel ball 127, thereby changing the force of the elastic element. It is understood that the elastic element is a spring.

The above are merely preferred embodiments of the present disclosure. Any equivalent changes or modifications made according to the construction, features, and principles within the patent scope of the present disclosure are intended to be included within the patent scope of the present disclosure.

1-14. (canceled)

15. A plug with a temperature-controlled circuit breaker, comprising:
a main body;
a lead end;
a live wire pin; and
a neutral wire pin;
wherein the lead end is fixed on a first end of the main body,
wherein the live wire pin and the neutral wire pin are provided on a second end of the main body, and
wherein an overheat/overcurrent protection component is connected in series between the lead end and the live wire pin, or an overheat/overcurrent protection component is connected in series between the lead end and the neutral wire pin.

16. The plug with temperature-controlled circuit breaker according to claim 15, wherein the overheat/overcurrent protection component comprises:
a connecting terminal;
a fixed contact piece; and
a bimetallic strip;
wherein the connecting terminal is fixedly connected to the fixed contact piece by an insulated terminal, and a static contact is arranged on the connecting terminal,
wherein the bimetallic strip has a first end fixedly connected to the fixed contact piece and the bimetallic strip has a second end provided with a moving contact, and
wherein either the live wire pin is fixedly connected to the fixed contact piece and a live wire at the lead end is connected to the connecting terminal of the overheat/overcurrent component, or the neutral wire pin is fixedly connected to the fixed contact piece and a neutral wire at the lead end is connected to the connecting terminal of the overheat/overcurrent protection component.

17. The plug with temperature-controlled circuit breaker according to claim 16, further comprising:
a second overheat/overcurrent protection component comprising:
a second connecting terminal;
a second fixed contact piece; and
a second bimetallic strip;
wherein the second connecting terminal is fixedly connected to the second fixed contact piece by a second insulated terminal,
wherein a second static contact is arranged on the second connecting terminal,
wherein the second bimetallic strip has a first end fixedly connected to the second fixed contact piece and a second end with a second moving contact,
wherein the live wire pin is fixedly connected to the fixed contact piece,
wherein the neutral wire pin is fixedly connected to the second fixed contact piece,
wherein the live wire at the lead end is connected to the connecting terminal of the overheat component, and
wherein the neutral wire at the lead end is connected to the second connecting terminal of the second overheat/overcurrent protection component.

18. The plug with temperature-controlled circuit breaker according to claim 17, wherein a positive temperature coefficient (“PTC”) element bridges the connecting terminal and the bimetallic strip, or a PTC element bridges the second connecting terminal and the second bimetallic strip.

19. The plug with temperature-controlled circuit breaker according to claim 18, wherein the moving contact is welded onto the bimetallic strip with a molten material, the static contact is welded onto the connecting terminal with a molten material, the second moving contact is welded onto the second bimetallic strip using a molten material, or the second static contact is welded onto the second connecting terminal using a molten material.

20. The plug with temperature-controlled circuit breaker according to claim 15, wherein the main body is further provided with a ground wire pin, and wherein the ground wire pin is electrically connected to the lead end.

21. The plug with temperature-controlled circuit breaker according to claim 20, wherein the main body further comprises:
a shell; and
a positioning module;
wherein the shell is a hollow structure with an upper opening,
wherein located within the upper opening of the shell is the positioning module composed of two constituent components which are arranged symmetrically, and are removably connected to each other to form a positioning opening,
wherein the lead end comprises a neck groove, and
wherein the neck groove is removably connected to the positioning opening such that the lead end is removably connected to the upper opening of the shell.

22. The plug with temperature-controlled circuit breaker according to claim 21, wherein the positioning module further comprises a plurality of limit blocks,
wherein the live wire pin, the neutral wire pin, and the ground wire pin each comprise a folding plate,
wherein the shell further comprises plug holes on a lower end surface of the shell, and
wherein the live wire pin, the neutral wire pin, and the ground wire pin insert through the plug holes of the shell, and wherein the limit blocks on the positioning module abut against the folding plates of the live wire pin, the neutral wire pin, and the ground wire pin.

23. The plug with temperature-controlled circuit breaker according to claim 22, wherein the positioning module further comprises a fixing hole, and wherein the positioning module is fixedly connected to the shell by the fixing hole and a fastener.

24. The plug with temperature-controlled circuit breaker according to claim 22,
wherein the limit block and the ground wire pin define an assembly groove,
wherein a ground wire at the lead end is embedded into the limit block and extends into the assembly groove, and the ground wire pin has an upper end provided with a quick replacement component,
wherein the quick replacement component comprises a conductive sleeve and a conductive pole,
wherein the conductive pole is fixedly connected to the upper end of the ground wire pin, and the conductive pole is slidably inserted into the conductive sleeve,
wherein the conductive sleeve has an upper end plate with a conductive pin, the conductive pin has an upper end with a second disc, and the conductive sleeve is slidably inserted into the assembly groove,
wherein the second disc contacts and is electrically connected to the ground wire, and the assembly groove is provided a first locking structure,
wherein a slide rod passes through the upper end plate of the conductive sleeve,
wherein the slide rod has a lower end fixedly connected to the conductive pole,
wherein the slide rod has an upper end provided with a first disc,
wherein the first disc and the second disc are positioned about the first locking structure, below and above the first locking structure respectively, and
wherein inside the conductive sleeve is a first spring, and the first spring abuts the upper end plate of the conductive sleeve and an upper end surface of the conductive pole.

25. The plug with temperature-controlled circuit breaker according to claim 24,
wherein the first locking structure comprises a first guide rod and a slope limit seat,
wherein a first chute is defined by walls of the assembly groove,
wherein inside the first chute is a first guide rod and an elastic element,
wherein the first guide rod has a first end fixedly connected to the assembly groove,
wherein the slope limit seat is slidably arranged on a second end of the first guide rod,
wherein the elastic element abuts against the slope limit seat, and
wherein the slope limit seat is removably connected to the first disc.

26. The plug with temperature-controlled circuit breaker according to claim 25:
wherein a second locking structure is located between the ground wire pin and the shell,
wherein the second locking structure comprises a second chute, a second guide rod, and a columnar locking tab,
wherein the second chute is arranged within the shell and adjacent to the conductive pole,
wherein the second chute contains the second guide rod and an elastic element,
wherein the conductive pole defines a first locking groove connected to the second chute,
wherein the second guide rod has a first end fixedly connected to the second chute,
wherein the columnar locking tab is slidably arranged on a second end of the second guide rod,
wherein the elastic element abuts against the columnar locking tab, and
wherein the columnar locking tab is removably connected to the first locking groove.

27. The plug with temperature-controlled circuit breaker according to claim 21:
wherein an assistant pairing structure is arranged between the positioning module and the lead end,
wherein the assistant pairing structure comprises a lock box containing a driving slider, a third guide rod, and a wedged driving head,
wherein the lock box is arranged adjacent to an upper end of the positioning module,
wherein the third guide rod is fixedly arranged inside the lock box and the driving slider is slidably connected to the third guide rod, and the lock box has an upper end surface defining a maintenance opening,
wherein inside the neck groove is defined a second locking groove,
wherein one end of the lock box is provided with a locking head inserted into the neck groove in a removably connected state, and the locking head is provided an elastic fastener,
wherein the wedged driving head is fixedly connected to the driving slider by a synchronous connecting rod, wherein inside the lock box is positioned an elastic element which abuts against the driving slider, and
wherein the elastic fastener is fitted about the wedged driving head.

28. The plug with temperature-controlled circuit breaker according to claim 21, wherein an assistant assembly structure is arranged between the positioning module and the shell,
wherein the assistant assembly structure comprises a steel ball, a rubber block, and an elastic element in a third locking groove defined within the positioning module,
wherein the third locking groove has a first end extending through an outer wall of the positioning module to form an opening,
wherein the shell has an inner wall defining a limit recess,
wherein the rubber block and the steel ball are inserted into the opening of the first end of the third locking groove, and
wherein an elastic element is arranged within the third locking groove and the elastic element drives the rubber block and the steel ball toward the limit recess.

29. The plug with temperature-controlled circuit breaker according to claim 28,
wherein the third locking groove has a second end provided with an adjusting screw,
wherein the adjusting screw is in threaded connection with the third locking groove, and
wherein an adjusting press plate is arranged inside the third locking groove, the adjusting screw having one end connected to the adjusting press plate, and the elastic element is arranged between the adjusting press plate and the rubber block.

30. A plug with temperature-controlled circuit breaker comprising:
a main body;
a lead end comprising a neck groove;
a shell;
a positioning module;
a first pin;
a second pin;
a third pin;
at least one overcurrent/overheat protection component;
wherein the lead end is fixed on a first end of the main body, and the first pin, the second pin, and the third pin are provided on a second end of the main body,
wherein the at least one overheat/overcurrent protection component is connected in series between the lead end and the first pin, or the at least one overheat/overcurrent protection component is connected in series between the lead end and the second pin,
wherein the shell is a hollow structure with an upper opening, and further comprises plug holes on a lower end surface of the shell,
wherein the positioning module is composed of at least two constituent components combined by removeable connection, and comprises a plurality of limit blocks,
wherein the positioning module defines a positioning opening, and the positioning module fits within the upper opening of the shell,
wherein the neck groove is removably connected to the positioning opening of the positioning module such that the lead end is removably connected to the upper opening of the shell,
wherein the first pin, the second pin, and the third pin each comprise a folding plate,
wherein the first pin, the second pin, and the third pin insert through the plug holes of the shell, and
wherein the limit blocks abut against the folding plates.

31. The plug with temperature-controlled circuit breaker of claim 30, further comprising:
a first locking structure; and
wherein the first locking structure unlocks the third pin when the third pin is slid upward.

32. The plug with temperature-controlled circuit breaker of claim 30, further comprising:
an assistant pairing structure comprising a maintenance opening;
wherein the assistant pairing structure couples the positioning module to the lead end, and
wherein the positioning module is separable from the lead end when a tool is applied to the maintenance opening.

33. The plug with temperature-controlled circuit breaker of claim 30, further comprising:
an assistant assembly structure; and
an adjusting screw;
wherein the assistant assembly structure locks the vertical positioning between the positioning module and the shell,
wherein the assistant assembly structure disengages the shell from the positioning module when a vertical force is applied to either the shell or the positioning module, and
wherein the vertical force required to disengage the shell from the positioning module is modifiable with the adjusting screw.

34. A plug with temperature-controlled circuit breaker comprising:
a main body;
a lead end which comprises a neck groove;
a shell;
a positioning module;
a live wire pin;
a neutral wire pin;
a ground wire pin;
at least one overcurrent/overheat protection components;
a first locking structure;
a second locking structure;
an overheat/overcurrent protection component;
an assistant pairing structure;
an assistant assembly structure; and
an adjusting screw;
wherein the lead end is fixed on a first end of the main body,
wherein the live wire pin, the neutral wire pin, and the ground wire pin are provided on a second end of the main body,
wherein the overheat/overcurrent protection component is connected in series between the lead end and the live wire pin, or the overheat/overcurrent protection component is connected in series between the lead end and the neutral wire pin,
wherein the shell is a hollow structure with an upper opening, and a lower end surface of the shell further comprises plug holes,
wherein the positioning module define a positioning opening,
wherein the positioning module comprises a plurality of limit blocks,
wherein the positioning module fits within the upper opening of the shell,
wherein the neck groove is removably connected to the positioning opening of the positioning module such that the lead end is removably connected to the upper opening of the shell,
wherein the live wire pin, the neutral wire pin, and the ground wire pin each comprise a folding plate,
wherein the live wire pin, the neutral wire pin, and the ground wire pin insert through the plug holes of the shell,
wherein the limit blocks abut against the folding plates of the live wire pin, the neutral wire pin, and the ground wire pin,
wherein the second locking structure unlocks the ground wire pin when the ground wire pin is rotated,
wherein, after the second locking structure is unlocked, the first locking structure unlocks the ground wire pin when the ground wire pin is slid upward,
wherein the assistant pairing structure comprises a maintenance opening,
wherein the use of a tool applied to the maintenance opening allows the positioning module to separate from the lead end,
wherein the assistant assembly structure disengages the shell from the positioning module when a vertical force is applied to either the shell or the positioning module, and
wherein the vertical force required to disengage the shell from the positioning module is modifiable with the adjusting screw.
